(19) United States
(12) Patent Application Publication
(10) Pub. No.: US 2014/0126026 A1
(43) Pub. Date: May 8, 2014

(54) FACSIMILE APPARATUS, METHOD OF CONTROLLING THE SAME AND STORAGE MEDIUM

(71) Applicant: CANON KABUSHIKI KAISHA, Tokyo (JP)

(72) Inventor: Katsuhiro Inoue, Kawasaki-shi (JP)

(21) Appl. No.: 14/038,840

(22) Filed: Sep. 27, 2013

(30) Foreign Application Priority Data
Nov. 7, 2012 (JP) 2012-245633

(51) Int. Cl. H04N 1/00

(52) U.S. Cl. CPC H04N 1/0083
USPC 358/468

(57) ABSTRACT

A facsimile apparatus that is capable of connecting to multiple lines including a first line. If a user designates the first line or the second line as a line to be used for image data transmission, the image data is transmitted via the designated line, and if the user designates that the line to be used for the image data transmission is to be automatically selected, image data transmission is performed via the first line. In the case where the image data is not able to be transmitted via the first line, if switching from the first line to the second line is set to be enabled, image data is transmitted via the second line, and if the switching is not set to be enabled, the image data is not transmitted via the second line.

### BACKGROUND OF THE INVENTION

1. Field of the invention

The present invention relates to a facsimile apparatus connected to an IP (Internet Protocol) network and a public telephone network, a method of controlling the same, and to a storage medium.

2. Description of the Related Art

In recent years, fax machines that include an IP facsimile communication function that uses an IP (Internet Protocol) network and conforms to SIP (Session Initiation Protocol) and T.38 standards have become widespread. SIP is a call control protocol for performing communication of various types of media, such as voice, data, and images, over an IP network defined by RFC 3261. T.38 is an ITU-T recommendation, and is a standard that defines the method of translating facsimile signals used on a subscribed telephone network into IP messages and transmitting them (see Japanese Patent Laid-Open No. 2003-169186).

This type of facsimile apparatus is connected to both an IP network and a public telephone network, and a user can perform facsimile transmission seamlessly without being concerned with whether the IP network or public telephone network (hereinafter referred to as PSTN) is used. In other words, if the IP network is available, the facsimile apparatus performs Internet facsimile (referred to below as “IPFAX”) transmission using the SIP and T.38 protocols. Also, in the case where the IP network cannot be used while IPFAX communication is in progress, G3FAX transmission is performed if the PSTN is available.

With a conventional facsimile apparatus connected to an IP network and a public telephone network (PSTN) as described above, G3FAX transmission is performed if the PSTN is available in the case where a fax transmission job is input while IPFAX communication using the IP network is in progress. Because of this, transmission is performed by G3FAX using the PSTN network, regardless of the fact that the fax that was originally intended to be transmitted by IPFAX can be transmitted by IPFAX after a short wait. Since G3FAX that uses a PSTN network has a slower communication speed compared to IPFAX transmission using an IP network, the communication cost is higher than that of IPFAX transmission. Thus, since G3FAX transmission using a PSTN network is performed regardless of the fact that IPFAX transmission is possible, there is a problem in that needless communication cost is incurred.

### SUMMARY OF THE INVENTION

An aspect of the present invention is to eliminate the above-mentioned problems with the conventional technology.

A feature of the present invention is to provide a technique for performing facsimile transmission via an IP network instead of performing transmission via a public telephone network even in the case where transmission is instructed while communication over the IP network is in progress.

According to an aspect of the present invention, there is provided a facsimile apparatus capable of connecting to a plurality of lines including a first line and a second line, the facsimile apparatus comprising: a first transmission control unit configured to, in a case where a user designates the first line or the second line as a line to be used for transmission of image data, control to transmit the image data via the designated line; a second transmission control unit configured to, in a case where the user designates that the line to be used for transmission of the image data is to be automatically selected, control to transmit the image data via the first line, and in a case where transmission via the first line is not able to be performed, control to transmit the image data via the second line; and a setting unit configured to set whether or not to enable switching from the first line to the second line by the second transmission control unit for transmission of the image data, wherein in a case where the transmission via the first line is not able to be performed, the second transmission control unit controls, if the switching from the first line to the second line is set to be enabled by the setting unit, to transmit the image data via the second line, and if the switching from the first line to the second line is not set to be enabled by the setting unit, not to transmit the image data via the second line.

Further features of the present invention will become apparent from the following description of exemplary embodiments with reference to the attached drawdings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a configuration of a facsimile apparatus according to an embodiment of the present invention.

FIG. 2 is a block diagram showing a software configuration of the facsimile apparatus according to the embodiment.

FIG. 3 is a flowchart for describing a call control operation of the facsimile apparatus according to the embodiment.

FIG. 4 is a conceptual diagram showing the Configuration of a network that the facsimile apparatus of the embodiment is connected to.

FIG. 5 is a diagram showing an example of a network selection screen displayed on a console unit of the facsimile apparatus.

FIG. 6 is a diagram showing an example of a screen for setting an IP prioritization mode that is displayed on the console unit of the facsimile apparatus.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

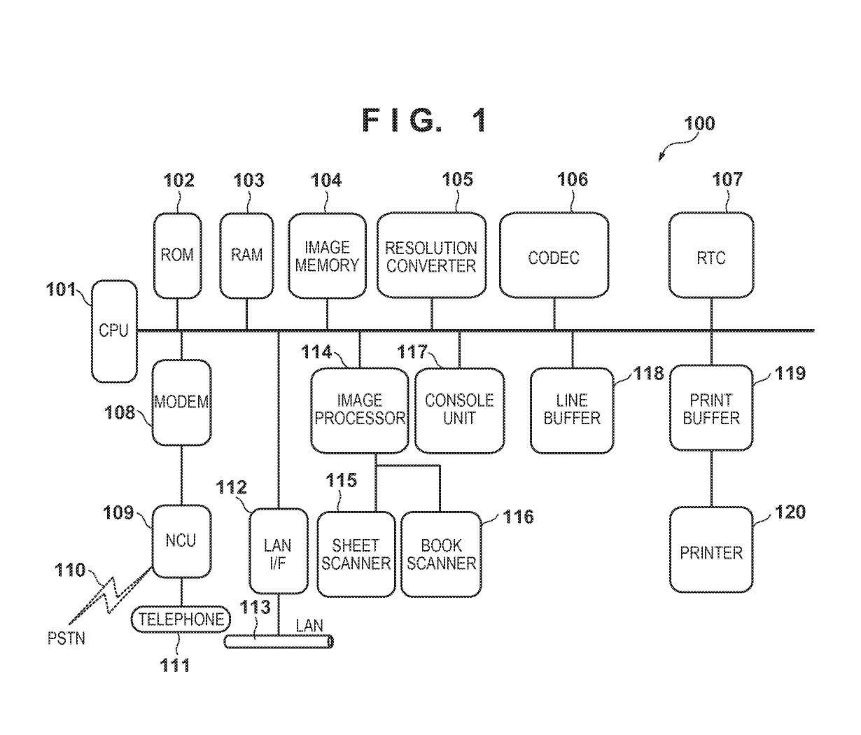

FIG. 1 is a block diagram showing a configuration of a facsimile apparatus 100 according to an embodiment of the present invention.

In FIG. 1, a CPU 101 performs overall control of this apparatus in accordance with a program stored in a ROM 102. The ROM 102 stores control programs for the CPU 101, various types of data, and the like. A RAM 103 includes an SRAM and the like, and provides a work area for temporarily storing various types of data during the operation of the CPU 101. An image memory 104 includes a DRAM and the like, and is used for accumulation of image data. A resolution converter 105 converts the resolution of image data. For example, the resolution converter 105 performs control of processes such as converting raster data in units of millimeters into raster data in units of inches. A codec 106 performs encoding and decoding processing on image data handled by a communication apparatus. An RTC (Real Time Clock) 107 measures a predetermined period of time in accordance with an instruction from the CPU 101, and measures time such as the current date and time.

A modem 108 demodulates modulated signals received from lines, and conversely modulates signals and transmits them. to ate lines. An NCU (Network Control Unit) 109 is an I/F unit that interfaces with an analog line (PSTN) 110. A telephone 111 includes a handset used for calling, and an answering machine function. A LAN I/F 112 controls communication with a network 113, such as a LAN. The network 113 is an IP network such as an internal. IP network or an NGN.

An image processor 114 carries out correction processing on image data scanned by a scanner and outputs high-definition image data. A sheet scanner 115 and a book scanner 116 each include a CIS (contact image sensor), an original transport mechanism, and the like, optically scan originals, generate and output electrical image data, and can scan both sides of an original. A console unit 117 includes a keyboard, a display unit with a touch panel function, and the like, displays messages and the like to the operator, and receives various types of input operations from the operator. The console unit 117 displays messages indicating that speed dialing can be performed when the handset of the telephone 111 is off the hook, and displays the fact that communication is in progress and that it is possible to receive communication reservations when the telephone 111 is off the hook.

A line buffer 118 is used in the case of controlling image data transfer and stores image data in units of lines. A print buffer 119 is one page-worth of buffer memory that stores print data of one page that is to be output to a printer 120. The printer 120 is a printer such as a laser-beam or inkjet printer that prints a received image or file data on regular paper, and can print on both sides.

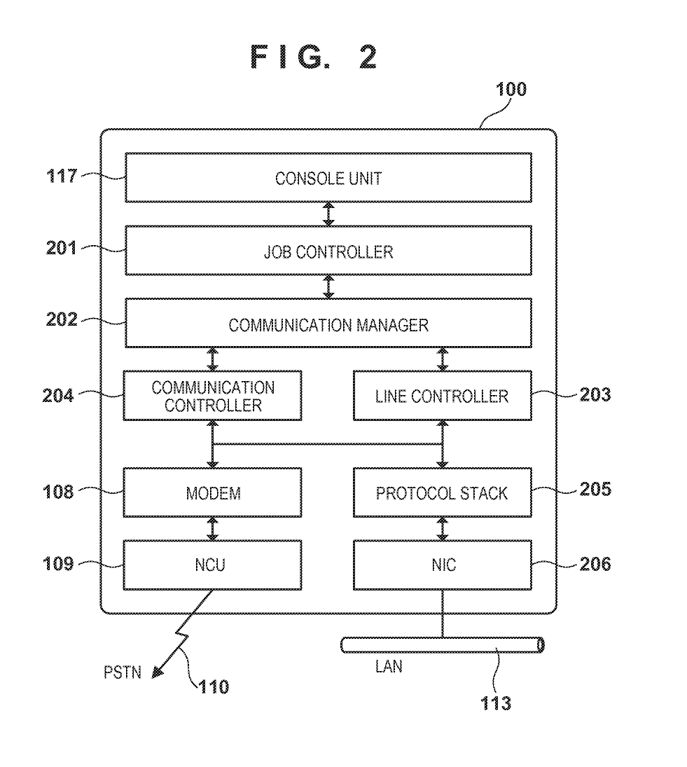

FIG. 2 is a block diagram showing a software configuration of the facsimile apparatus 100 according to this embodiment of the present invention.

When an operation for FAX transmission is performed with the console unit 117, a job controller 201 generates a FAX transmission job and notifies a communication manager 202. The communication manager 202 requests a line controller 203 to perform outgoing call processing, using job information such as network selection information (IP/PSTN) notified by the job controller 201.

Here, if the network selection information is PSTN, G3 facsimile transmission is to be performed, and therefore the modem 108 and the NCU 109 are notified by the line controller 203 to perform a dial operation. When this call origination ends and a connection to the other party is established, the communication manager 202 causes a communication controller 204 to start up, and executes G3 facsimile communication by performing T.30 protocol control with respect to the modem 108 and the NCU 109.

On the other hand, if the network selection information is an IP network, internet facsimile transmission (hereinafter referred to as “IPFAX transmission”) is performed using the SIP and T.38 protocols. Accordingly, in this case, the line controller 203 notifies a protocol stack 205 to connect to the other party with the SIP protocol. The SIP message created by The protocol stack 205 is transmitted to the LAN (IP network) 113 via an NIC 206. When the session with the other party using the SIP protocol is generated in this way, the communication controller 204 executes a real-time internet facsimile procedure according to T.38 with the connection destination.

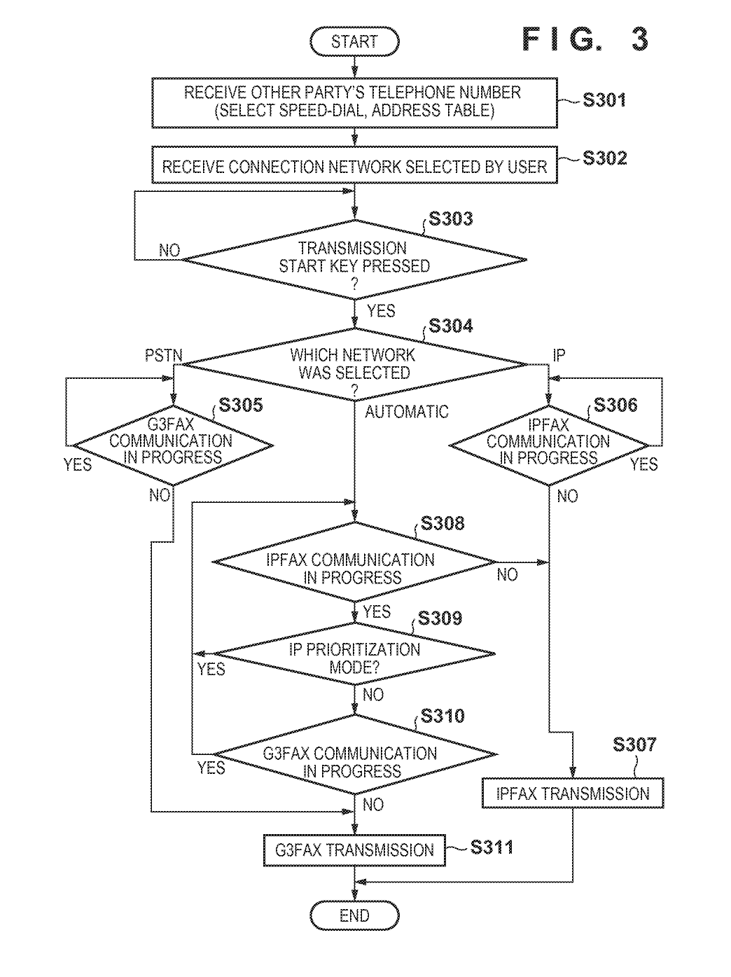

FIG. 3 is a flowchart for describing the outgoing call control operation of the facsimile apparatus 100 according to the embodiment of the present invention. A program for executing this processing is stored in the ROM 102 and executed under the control of the CPU 101.

This processing is started by the user setting the original to be transmitted on the scanner 115, and subsequently inputting the other party's telephone number using a numeric keypad or the like on the console unit 117 (speed-dial or address list may be selected). First, in step S301, the CPU 101 receives the other party's telephone number input by the user. Next, in step S302, the CPU 101 receives the designation of the network to connect to, which the user selected with the network selection screen displayed on the display unit of the console unit 117, and stores it in the RAM 103.

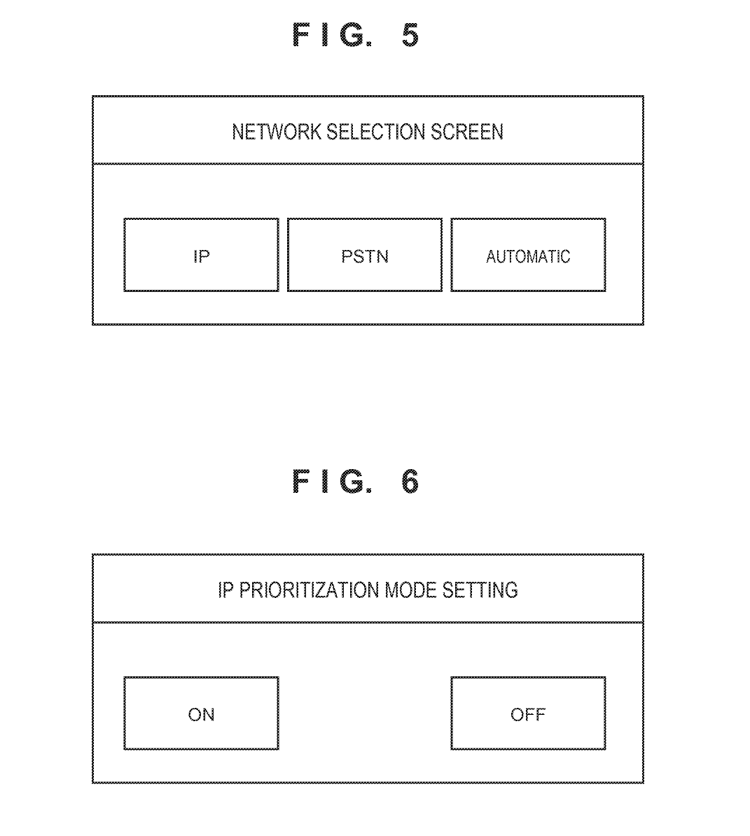

FIG. 5 is a diagram showing an example of a network selection screen displayed on the display unit of the console unit 117.

The network selection screen displays an “IP” button, a “PSTN”, and an “automatic” button. Here, it is possible for the user to select “IP”, “PSTN”, or “automatic” as the network to connect to for facsimile transmission. by touching a corresponding button. Here, “IP” indicates an IP network, and “PSTN” indicates a public telephone network. Additionally, “automatic” gives an instruction to connect to an available network out of the IP network and the public telephone network. The selection on the network selection screen is arbitrary, and the default setting is “automatic”. Note that in the case of selecting “automatic”, if transmission by IPFAX is possible, facsimile transmission is performed using an IP network.

Next, moving to step S303, the CPU 101 determines whether or not a start key on the console unit 117 was pressed. If the start key for instructing the start of transmission is pressed, the procedure advances to step S304, and the CPU 101 identifies the network that is selected by the user using the screen in FIG. 5 and stored in step S302. Here, if the PSTN is selected, the procedure advances to step S305 and the CPU 101 determines whether or not communication by G3FAX is in progress. If the communication is not in progress, the procedure advances to step S311, and transmission by G3FAX is performed. If the communication by G3FAX is in progress, the CPU 101 waits for the G3FAX communication to end, whereafter the procedure by G3FAX to step S311, and transmission by G3FAX is performed.

If the IP network is selected in step S304, the procedure advances to step S306, and the CPU 101 determines whether or not communication by IPFAX is in progress. If the IPFAX communication is not in progress, the procedure advances to step S307, and transmission by IPFAX is performed. Additionally, if the communication by IPFAX is in progress in step S306, the CPU 101 waits for the communication by IPFAX to end, whereafter the procedure advances to step S307, and the transmission by IPFAX is performed.

On the other hand, if “automatic” is selected in step S304, the procedure advances to step S308, and the CPU 101 identifies the networks that connect the facsimile apparatus 100 and a facsimile apparatus of the transmission destination. Here, they are connected with both the IP network and the public telephone network. Accordingly, in step S308, the CPU 101 first determines whether or not communication by IPFAX is in progress. If the communication by IPFAX is not in progress, the procedure advances to step S307, and the CPU 101 performs communication by IPFAX. On the other hand, if the communication by IPFAX is in progress in step S308, the procedure advances to step S309, and the CPU 101 determines whether or not an IP prioritization mode has been set. If the IP prioritization mode has been set, the procedure returns to step S308, the CPU 101 waits for the communication by IPFAX to end, and then the procedure advances to step S307.

On the other hand, if the IP prioritization mode has not been set in step S309, the procedure advances to step S310, and the CPU 101 determines whether or not communication by G3FAX is in progress. Here, if the communication by G3FAX is not in progress, the procedure advances to step S311, and the CPU 101 performs transmission by G3FAX. Additionally, if the communication by G3FAX is in progress in step S310, the procedure returns to step S308, and the above-described processing is performed.

FIG. 6 is a diagram showing an example of a screen for setting the IP prioritization mode displayed on the display unit of on the console unit 117. Note that in contrast to the screen in FIG. 5 being displayed when a general user performs an operation on the facsimile apparatus, the screen in FIG. 6 is displayed only when a specific administrator (a person in charge of IT at a company) or a specific serviceperson (a technician dispatched by the facsimile apparatus vendor) performs an operation.

Here, when the “ON” button is pressed, the IP prioritization mode is set, and when the “OFF” button is pressed, the IP prioritization mode is not set. The content set on this screen is stored in the RAM 103 and referenced in step S309 in FIG. 3.

Thus, according to the facsimile apparatus 100 of the present embodiment, it is possible to designate a line for facsimile transmission, and if “automatic” is selected, an available network is selected from either IPFAX or G3FAX, and transmission is performed. Since it is determined in advance whether or not IPFAX can be used (step S308), transmission by IPFAX is performed when both IPFAX and G3FAX can be used.

Furthermore, if the IP prioritization mode has been set, the CPU will wait for transmission by IPFAX to become available and then perform transmission by IPFAX, even if transmission by G3FAX is available. This has an effect of preventing needless communication cost from being incurred due to transmission by G3FAX, even when a fax job is newly input while IPFAX communication is in progress. In particular, in the case where “automatic” is selected, it is possible to prevent communication cost from increasing due to the unintended execution of G3FAX by a user who is unaware that G3FAX transmission will be performed if other communication is being executed even when IPFAX transmission is available.

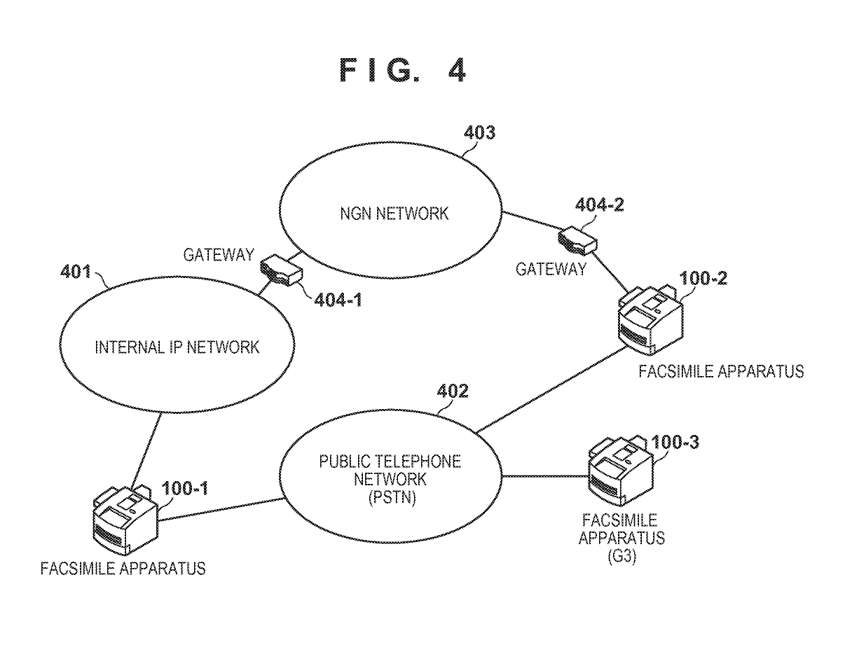

FIG. 4 is a conceptual diagram showing the configuration of a network to which the facsimile apparatus of the present embodiment is connected.

Both facsimile apparatuses 100-1 and 100-2 in FIG. 4 are configured as the facsimile apparatus 100 shown in FIG. 1. A facsimile apparatus 100-3 is a G3 facsimile apparatus. The facsimile apparatus 100-1 is connected to an internal IF network 401 and a public telephone network 402, and the facsimile apparatus 100-2 is connected to the public telephone network 402 and an NGN network 403. Also, the facsimile apparatus 100-3 is connected only to the public telephone network 402. NGN is an abbreviation for Next Generation Network, which indicates a next-generation network for the purpose of providing a telephone and image communication service.

In such a connection environment, the facsimile apparatus 100-1, for example, communicates with the facsimile apparatus 100-2 via the internal IP network 401, a gateway 404-1, the NGN network 403, and a gateway 404-2. Additionally, the facsimile apparatus 100-1 can communicate with the facsimile apparatus 100-3 via the public telephone network 402.

For example, in the case where facsimile communication is to be performed from the facsimile apparatus 100-1 to another facsimile apparatus, a user of the facsimile apparatus 100-1 performs an operation on keys on the console unit 117 and inputs the telephone number of the transmission destination when a call is to be made. Then, the user selects on the network selection screen in FIG. 5 whether to make a call to the internal IP network 401 or the public telephone network 402, or selects “automatic” (a mode for automatically identifying networks). In the case where the transmission destination is the facsimile apparatus 100-2, if “automatic” is selected on the network selection screen, the networks that connect the facsimile apparatus 100-1 and the facsimile apparatus 100-2 are automatically identified based on the telephone number of the transmission destination. Then, transmission. by IPFAX over the IP network 401 will be attempted first. If communication by IPFAX is already in progress at this time, the CPU 101 checks the IP prioritization mode setting, and if the IP prioritization mode has been set, the CPU 101 waits for the communication by IPFAX that is progress to end and then performs the transmission using IPFAX. On the other hand, if the IP prioritization mode has not been set, transmission is performed by G3FAX via the public telephone network 402.

In the case where a fax job is newly input while IPFAX communication is in progress, this kind of configuration has an effect of being able to prevent needless communication cost from being incurred, due to G3FAX transmission being performed via a PSTN network, which has a slower communication speed compared to IPFAX.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-245633, filed Nov. 7, 2012, which is hereby incorporated by reference herein in its entirety.

What is claimed is

1. A facsimile apparatus capable of connecting to a plurality of lines including a first line and a second line, the facsimile apparatus comprising:
a first transmission control unit configured to, in a case where a user designates the first line or the second line as a line to be used for transmission of image data, control to transmit the image data via the designated line;
a second transmission control unit configured to, in a case where the user designates that the line to be used for transmission of the image data is to be automatically selected, control to transmit the image data via the first line, and in a case where transmission via the first line is not able to be performed, control to transmit the image data via the second line; and
a setting unit configured to set whether or not to enable switching from the first line to the second line by the second transmission control unit for transmission of the image data,
wherein in a case where the transmission via the first line is not able to be performed, the second transmission control unit controls, if the switching from the first line to the second line is set to be enabled by the setting unit, to transmit the image data via the second line, and if the switching from the first line to the second line is not set to be enabled by the setting unit, not to transmit the image data via the second line.

2. The facsimile apparatus according to claim 1, further comprising:
a display unit configured to display a line selection screen, for a user, to select the first line, the second line, or automatic selection of a line.

3. The facsimile apparatus according to claim 2,
wherein a selection via the line selection screen is performed based on an instruction from a general user, and the setting performed by the setting unit is performed based on an instruction from an administrator of the facsimile apparatus.

4. The facsimile apparatus according to claim 1,
wherein the first line is an IP network, and the second line is a public line network.

5. A facsimile apparatus capable of connecting to a plurality of lines including a first line and a second line, the facsimile apparatus comprising:
a first transmission control unit configured to, in a case where a user performs a first designation, transmit image data via the first line, and in a case where transmission via the first line is not able to be performed, wait for transmission via the first line to be possible and then transmit the image data via the first line;
a second transmission control unit configured to, in a case where a user performs a second designation, control to transmit the image data via the first line, and in a case where transmission via the first line is not able to be performed, control to transmit the image data via the second line; and
a setting unit configured to set whether or not to enable switching from the first line to the second line by the second transmission control unit for transmission of the image data,
wherein in a case where transmission via the first line is not able to be performed, the second transmission control unit controls, if the switching from the first line to the second line is set to be enabled by the setting unit, to transmit the image data via the second line, and if the switching from the first line to the second line is not set to be enabled by the setting unit, not to transmit the image data via the second line.

6. The facsimile apparatus according to claim 5, further comprising:
a display unit configured to display a screen for receiving toe first designation or the second designation.

7. The facsimile apparatus according to claim 6,
wherein a designation via the screen is performed based on an instruction from a general user, and the setting performed by the setting unit is performed based on an instruction from an administrator of the facsimile apparatus.

8. The facsimile apparatus according to claim 5,
wherein the first line is an IP network, and the second line is a public line network.

9. A facsimile apparatus capable of connecting to a plurality of lines including a first line and a second line, the facsimile apparatus comprising:
a first transmission control unit configured to, in a case where a user designates the first line or the second line as a line to be used for transmission of image data, control to transmit the image data via the designated line;
a second transmission control unit configured to, in a case where the user designates that the line to be used for transmission of the image data is to be automatically selected, control to transmit the image data via the first line, and in a case where transmission via the first line is not able to be Performed, control to transmit the image data via the second line; and
a setting unit configured to set whether or not to enable switching from the first line to the second line by the second transmission control unit.

10. The facsimile apparatus according to claim 9, further comprising:
a display unit configured to display a line selection screen, for a user, to select the first line, the second line, or automatic selection of a line.

11. The facsimile apparatus according to claim 10,
wherein a designation via the line selection screen is performed based on an instruction from a general user, and the setting performed by the setting unit is performed based on an instruction from an administrator of the facsimile apparatus.

12. The facsimile apparatus according to claim 9,
wherein the first line is an IP network, and the second line is a public line network.

13. A method of controlling a facsimile apparatus capable of connecting to a plurality of lines including a first line and a second line, the method comprising:
transmitting the image data via the designated line, in a case where a user designates the first line or the second line as a line to be used for transmission of image data;
controlling, in a case where the user designates that the line to be used for transmission of the image data is to be automatically selected, to transmit the image data via the first line, and in a case where transmission via the first line is not able to be performed, to transmit the image data via the second line; and
setting whether or not to enable switching from the first line to the second line,
wherein in a case where transmission via the first line is not able so be performed, she controlling step controls, if the switching from the first line to the second line is set to be enabled in the setting step, to transmit the image data via the second line, and if the switching from the first line to the second line is not set to be enabled in the setting step, the controlling step controls not to transmit the image data via the second line.

14. A method of controlling a facsimile apparatus capable of connecting to a plurality of lines including a first line and a second line, the method comprising:
transmitting image data via the first line, in a case where a user performs a first designation, and, in a case where transmission via the first line is not able to be performed, waiting for transmission via the first line to be possible and then transmitting the image data via the first line;
controlling, in a case where the user makes a second designation, to transmit the image data via the first line, and in a case where transmission via the first line is not able to be performed, to transmit the image data via the second line; and
setting whether or not to enable switching from the first line to the second line,
wherein in a case where transmission via the first line is not able to be performed, the controlling step controls, if the switching from the first line to the second line is set to be enabled in the setting step, to transmit the image data via the second line, and if the switching from the first line to the second line is not set to be enabled in the setting step, the controlling step controls not to transmit the image data via the second line.

15. A method of controlling a facsimile apparatus capable of connecting to a plurality of lines including a first line and a second line, the method comprising:
transmitting the image data via the designated line, in a case where a user designates the first line or the second line as a line to be used for transmission of image data;
controlling, in a case where the user designates that the line to be used for transmission of the image data is to be automatically selected, to transmit the image data via the first line, and in a case where transmission via the first line is not able to be performed, to transmit the image data via the second line; and
setting whether or not to enable switching from the first line to the second line.

16. A non-transitory storage medium storing a program for causing a computer to execute the method according to claim 13.

17. A non-transitory storage medium storing a program for causing a computer to execute the method according to claim 14.

18. A non-transitory storage medium storing a program for causing a computer to execute the method according to claim 15.
